(19) United States
(12) Patent Application Publication
(10) Pub. No.: US 2025/0249503 A1
(43) Pub. Date: Aug. 7, 2025

(54) SILVER MICROPARTICLE

(71) Applicant: NISSHIN ENGINEERING INC., Tokyo (JP)

(72) Inventors: Shiori SUEYASU, Fujimino-city (JP); Shu WATANABE, Fujimino-city (JP)

(21) Appl. No.: 18/853,040

(22) PCT Filed: Mar. 23, 2023
(86) PCT No.: PCT/JP2023/011397

§ 371 Date: Sep. 30, 2024

(30) Foreign Application Priority Data
Mar. 31, 2022 (JP) 2022-059713

(51) Int. Cl. B22F 1/102; B22F 1/05

(52) U.S. Cl. CPC B22F 1/102; B22F 1/05; B22F 2301/255; B22F 2304/056; B22F 2304/058

(57) ABSTRACT

Provided are silver fine particles having large volume contraction and high electrical conductivity. Of silver fine particles, a particles size measured by BET method is 0.1 μm or more and 1 μm or less, and the silver fine particles in a form of pellet having been baked in a nitrogen atmosphere at temperature of 100° C. for 1 hour has a volume resistivity of 15 μΩ·cm or lower and a volume contraction rate of 5% or more.

### TECHNICAL FIELD

The present invention relates to silver fine particles for use in, for example, bonding between a semiconductor device, a high-frequency device, a light-emitting diode, a semiconductor laser, or the like and a substrate or the like.

### BACKGROUND ART

At present, power semiconductor devices using a wide-bandgap semiconductor such as silicon carbide (SiC), gallium nitride (GaN), gallium oxide, or diamond have been developed. A power semiconductor device has a lower on-resistance than that of a semiconductor device using Si or GaAs, is capable of high-speed switching, and, in addition, can be reduced in size. Moreover, a power semiconductor device has high heat resistance and can operate at high temperature of 250 to 300° C.

For bonding between a semiconductor device and a substrate or the like, solder has been conventionally used. However, while an operation temperature of a power semiconductor device is higher than that of a conventional semiconductor device using Si or GaAs, a power semiconductor device bonded with solder requires to be used at temperature at which solder does not melt. In a case where solder is used for bonding, a power semiconductor device has limitation in its use. Accordingly, there is also a demand for a bonding material which can be used at high temperature.

Patent Literature 1 describes a different bonding material from solder, i.e., a thermal conductive paste including low-temperature sinterable silver fine particles and a thermosetting binder, the thermosetting binder comprising (B1) at least one epoxy resin selected from the group consisting of diglycidyl phthalate ester, diglycidyl tetrahydrophthalate ester, diglycidyl hexahydrophthalate ester, and C1 to C4 alkyl substitution products thereof, and (B2) at least one curing agent selected from the group consisting of a cationic polymerization initiator, an amine-based curing agent, and an acid anhydride curing agent, wherein an amount of the thermosetting binder is 2 to 7 parts by mass with respect to 100 parts by mass of the silver fine particles.

### CITATION LIST

### Patent Literatures

Patent Literature 1: JP 6343041 B

### SUMMARY OF INVENTION

### Technical Problems

When containing a thermosetting binder as in Patent Literature 1, a bonding material has a low volume contraction rate.

Today, not only a single semiconductor device is bonded to a substrate, but also a plurality of semiconductor devices having different sizes are bonded to a single substrate at a time. When a plurality of semiconductor devices having different sizes are bonded, a semiconductor device having a low height and a semiconductor device having a high height have different distances to a substrate; with use of a bonding material having a low volume contraction rate as in Patent Literature 1 described above, the semiconductor devices cannot be evenly bonded to the substrate, and a sufficient bonding state cannot be maintained. For bonding a plurality of semiconductor devices having different distances to a substrate, it is necessary to adjust volume contraction of the bonding material depending on the distance between a semiconductor device and the substrate, and with only a bonding material having small volume contraction, a sufficient bonding state between the substrate and the semiconductor devices cannot be maintained. Accordingly, a bonding material having large volume contraction is required. In addition, a bonding material preferably has excellent electrical conductivity.

The present invention has an object to provide silver fine particles having large volume contraction and high electrical conductivity.

### Solution to Problems

In order to attain the above-described object, an embodiment of the present invention provides silver fine particles, wherein a particles size measured by BET method is 0.1 μm or more and 1 μm or less, and the silver fine particles in a form of pellet having been baked in a nitrogen atmosphere at temperature of 100° C. for 1 hour has a volume resistivity of 15 μΩ·cm or lower and a volume contraction rate of 5% or more.

It provides silver fine particles, wherein a particles size measured by BET method is 0.1 μm or more and 1 μm or less, and the silver fine particles in a form of pellet having been baked in a nitrogen atmosphere at temperature of 150° C. for 1 hour has a volume resistivity of 10 μΩ·cm or lower and a volume contraction rate of 10% or more.

It provides silver fine particles, wherein a particles size measured by BET method is 0.1 μm or more and 1 μm or less, and the silver fine particles in a form of pellet having been baked in air at temperature of 150° C. for 1 hour has a volume resistivity of 10 μΩ·cm or lower and a volume contraction rate of 5% or more.

Surfaces of the silver fine particles are preferably covered by an aliphatic amine.

The aliphatic amine preferably has 10 to 18 carbon atoms.

### Advantageous Effects of Invention

According to the invention, it is possible to provide silver fine particles having large volume contraction and high electrical conductivity.

### BRIEF DESCRIPTION OF DRAWINGS

FIG. 1 is a schematic view showing an example of use form of silver fine particles of the invention.

FIG. 2 is a schematic view showing another example of use form of the silver fine particles of the invention.

FIG. 3 is a schematic view showing an example of a silver fine particle production apparatus of the invention.

FIG. 4 is a schematic view showing an SEM image of silver fine particles of Example 1 of the invention.

FIG. 5 is a schematic view showing an SEM image of silver fine particles of Example 2 of the invention.

### DESCRIPTION OF EMBODIMENTS

On the following pages, silver fine particles of the present invention are described in detail with reference to a preferred embodiment shown in the accompanying drawings. It should be noted that the drawings described below are illustrative to describe the invention, and the invention is not construed to be limited to the drawings described below.

Below, the silver fine particles are described.

### First Example of Silver Fine Particles

The silver fine particles have a particle size measured by the BET method of 0.1 μm or more and 1 μm or less, and the silver fine particles in a form of pellet having been baked in a nitrogen atmosphere at temperature of 100° C. for 1 hour have a volume resistivity of 15 μΩ·cm or lower and a volume contraction rate of 5% or more. In the invention, a nitrogen atmosphere means an atmosphere where nitrogen gas of 99.99 purity (nitrogen: 99.99 vol %) is constantly circulated and where the oxygen concentration is 100 volume ppm or lower. Hence, in a nitrogen atmosphere, nitrogen can be mixed with a gas with which the oxygen concentration can be 100 volume ppm or lower and which or whose decomposed product does not react with silver, e.g., a rare gas or the like. The oxygen concentration can be measured using, for example, a low concentration oxygen analyzer PS-820-L manufactured by Iijima Electronics Corporation.

The particle size of the silver fine particles is preferably 100 nm to 400 nm, and more preferably 300 nm to 400 nm from the viewpoint of handleability when being dispersed and a small volume contraction rate of the silver fine particles in a form of pellet having been baked in a nitrogen atmosphere at temperature of 100° C. for 1 hour.

The volume resistivity is 15 μΩ·cm or lower, preferably 10 μΩ·cm or lower, and more preferably 8 μΩ·cm or lower. The lower limit of the volume resistivity is 1.47 μΩ·cm.

The volume contraction rate is 5% or more, and preferably 6% or more. The upper limit of the volume contraction rate is 40%.

The particle size of the silver fine particles measured by the BET method is the average particle size measured using the BET method. In the BET method, particles are assumed to be spherical, and the calculation is made based on the specific surface area.

The silver fine particles are not present in a dispersed form in a solvent or the like but are present alone without a solvent or the like. Hence, when the silver fine particles are used, a baked body can be obtained only from the silver fine particles.

In addition, when the silver fine particles are used in combination with a solvent, there is no particular limitation on the combination with a solvent, and the degree of freedom is high in selection of a solvent.

In the baking process, the silver fine particles are formed into a pellet of cylindrical shape, and the pellet is placed in an electric furnace and baked in a nitrogen atmosphere at temperature of 100° C. for 1 hour.

The pellet is prepared by pressing and retaining the silver fine particles at pressure of 127 MPa for 10 seconds with a pressing machine.

The volume resistivity is a value obtained by measuring through the four-terminal method using the pellet. For example, Loresta EP (MCP-T360) manufactured by Mitsubishi Chemical Corporation is used as a measurement device. By measuring the volume resistivity of the pellet before and after the baking process, the change in the volume resistivity following the baking process can be measured.

The volume contraction rate is a value obtained as follows: the silver fine particles are pressed and retained at pressure of 127 MPa for 10 seconds with a pressing machine as described above to prepare a pellet of cylindrical shape, the thickness and the diameter of the pellet of cylindrical shape are measured with a caliper, and calculation is made based on the volumes of the pellet before and after the baking process. The volume contraction rate is obtained using the following formula. Meanwhile, an electric furnace is used to bake the pellet.

Volume contraction rate (%)=100−((volume after baking/volume before baking)×100)

Since the silver fine particles have a particle size measured by the BET method of 0.1 μm or more and 1 μm or less while the silver fine particles in a form of pellet having been baked in a nitrogen atmosphere at temperature of 100° C. for 1 hour have a volume resistivity of 15 μΩ·cm or lower and a volume contraction rate of 5% or more, the silver fine particles have large volume contraction and high electrical conductivity. In addition, the silver fine particles have a higher melting point than that of solder or the like and are also excellent in heat resistance. Accordingly, when the silver fine particles are used as a bonding material, the heat resistance is satisfactory, and excellent electrical conductivity can be achieved.

### Second Example of Silver Fine Particles

The silver fine particles have a particle size measured by the BET method of 0.1 μm or more and 1 μm or less, and the silver fine particles in a form of pellet having been baked in a nitrogen atmosphere at temperature of 150° C. for 1 hour have a volume resistivity of 10 μΩ·cm or lower and a volume contraction rate of 10% or more.

The particle size of the silver fine particles is preferably 100 nm to 600 nm, more preferably 300 nm to 600 nm, yet more preferably 300 nm to 500 nm, and most preferably 300 nm to 400 nm from the viewpoint of handleability when being dispersed and a small volume contraction rate of the silver fine particles in a form of pellet having been baked in a nitrogen atmosphere at temperature of 150° C. for 1 hour.

The volume resistivity is 10 μΩ·cm or lower, preferably 7 μΩ·cm or lower, and more preferably 4 μΩ·cm or lower. The lower limit of the volume resistivity is 1.47 μΩ·cm.

The volume contraction rate is 10% or more, preferably 13% or more, and more preferably 15% or more. The upper limit of the volume contraction rate is 40%.

The particle size of the silver fine particles measured by the BET method is as described above.

In the baking process, the silver fine particles are formed into a pellet of cylindrical shape, and the pellet is placed in an electric furnace and baked in a nitrogen atmosphere at temperature of 150° C. for 1 hour.

The pellet is prepared by pressing and retaining the silver fine particles at pressure of 127 MPa for 10 seconds with a pressing machine.

The volume resistivity is a value obtained by measuring through the four-terminal method using the pellet. For example, Loresta EP (MCP-T360) manufactured by Mitsubishi Chemical Corporation is used as a measurement device. By measuring the volume resistivity of the pellet before and after the baking process, the change in the volume resistivity following the baking process can be measured.

The volume contraction rate is a value obtained as follows: the silver fine particles are pressed and retained at pressure of 127 MPa for 10 seconds with a pressing machine as described above to prepare a pellet of cylindrical shape, the thickness and the diameter of the pellet of cylindrical shape are measured with a caliper, and calculation is made based on the volumes of the pellet before and after the baking process. The volume contraction rate is obtained using the following formula. Meanwhile, an electric furnace is used to bake the pellet.

Volume contraction rate (%)=100−((volume after baking/volume before baking)×100)

Since the silver fine particles have a particle size measured by the BET method of 0.1 μm or more and 1 μm or less while the silver fine particles in a form of pellet having been baked in a nitrogen atmosphere at temperature of 150° C. for 1 hour have a volume resistivity of 10 μΩ·cm or lower and a volume contraction rate of 10% or more, the silver fine particles have large volume contraction and high electrical conductivity. In addition, the silver fine particles have a higher melting point than that of solder or the like and are also excellent in heat resistance. Accordingly, when the silver fine particles are used as a bonding material, the heat resistance is satisfactory, and excellent electrical conductivity can be achieved.

### Third Example of Silver Fine Particles

The silver fine particles have a particle size measured by the BET method of 0.1 μm or more and 1 μm or less, and the silver fine particles in a form of pellet having been baked in the air at temperature of 150° C. for 1 hour have a volume resistivity of 10 μΩ·cm or lower and a volume contraction rate of 5% or more.

The air in the present invention means the atmosphere generally called air. The air is also referred to as air atmosphere. The air composition includes 78.08 vol % of nitrogen, 20.95 vol % of oxygen, 0.93 vol % of argon, and 0.03 vol % of carbon dioxide. An ordinary measurement error is allowed in relation to the air composition.

The particle size of the silver fine particles is preferably 100 nm to 600 nm, more preferably 300 nm to 600 nm, yet more preferably 300 nm to 500 nm, and most preferably 300 nm to 400 nm from the viewpoint of handleability when being dispersed and a small volume contraction rate of the silver fine particles in a form of pellet having been baked in the air (air atmosphere) at temperature of 150° C. for 1 hour.

The volume resistivity is preferably 8 μΩ·cm or lower, more preferably 7 μΩ·cm or lower, and most preferably 5 μΩ·cm or lower. The lower limit of the volume resistivity is 1.47 μΩ·cm.

The volume contraction rate is 5% or more, preferably 6% or more, and more preferably 7% or more. The upper limit of the volume contraction rate is 40%.

The particle size of the silver fine particles measured by the BET method is as described above.

In the baking process, the silver fine particles are formed into a pellet of cylindrical shape, and the pellet is placed in an electric furnace and baked in the air at temperature of 150° C. for 1 hour.

The pellet is prepared by pressing and retaining the silver fine particles at pressure of 127 MPa for 10 seconds with a pressing machine.

The volume resistivity is a value obtained by measuring through the four-terminal method using the pellet. For example, Loresta EP (MCP-T360) manufactured by Mitsubishi Chemical Corporation is used as a measurement device. By measuring the volume resistivity of the pellet before and after the baking process, the change in the volume resistivity following the baking process can be measured.

The volume contraction rate is a value obtained as follows: the silver fine particles are pressed and retained at pressure of 127 MPa for 10 seconds with a pressing machine as described above to prepare a pellet of cylindrical shape, the thickness and the diameter of the pellet of cylindrical shape are measured with a caliper, and calculation is made based on the volumes of the pellet before and after the baking process. The volume contraction rate is obtained using the following formula. Meanwhile, an electric furnace is used to bake the pellet.

Volume contraction rate (%)=100−((volume after baking/volume before baking)×100)

Since the silver fine particles have a particle size measured by the BET method of 0.1 μm or more and 1 μm or less while the silver fine particles in a form of pellet having been baked in the air at temperature of 150° C. for 1 hour have a volume resistivity of 10 μΩ·cm or lower and a volume contraction rate of 5% or more, the silver fine particles have large volume contraction and high electrical conductivity. In addition, the silver fine particles have a higher melting point than that of solder or the like and are also excellent in heat resistance. Accordingly, when the silver fine particles are used as a bonding material, the heat resistance is satisfactory, and excellent electrical conductivity can be achieved.

Surfaces of any of the silver fine particles described above are preferably covered by an aliphatic amine. For example, an aliphatic amine is present as a surface coating of the silver fine particles. The aliphatic amine preferably has 10 to 18 carbon atoms and more preferably 12 to 16 carbon atoms from the viewpoint of large volume contraction and high electrical conductivity.

Examples of the aliphatic amine include dodecylamine and hexadecyl amine. Dodecylamine and hexadecyl amine have a straight chain structure.

Presence and the composition of the surface coating of the silver fine particles can be examined using, for instance, a Fourier transform infrared spectrometer (FT-IR).

### [Use Form of Silver Fine Particles]

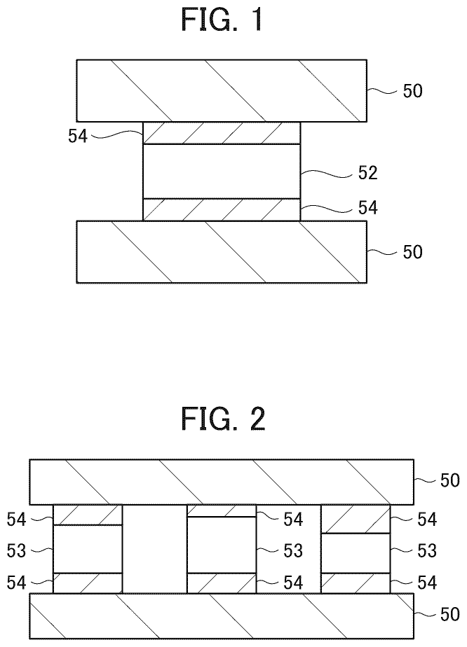

FIG. 1 is a schematic view showing an example of use form of the silver fine particles of the invention, and FIG. 2 is a schematic view showing another example of use form of the silver fine particles of the invention.

For instance, the silver fine particles are used to bond between a substrate 50 and a power semiconductor device 52 shown in FIG. 1. The silver fine particles are used for die attachment.

The silver fine particles constitute a bonding portion 54 bonding between the substrate 50 and the power semiconductor device 52. The bonding portion 54 is formed by baking the silver fine particles at, for example, temperature of 100° C. or 150° C. for 1 hour in a nitrogen atmosphere or in the air. The bonding portion 54 bonds between the substrate 50 and the power semiconductor device 52, and the substrate 50 is thus physically fixed to the power semiconductor device 52.

The silver fine particles are also used to bond between a single substrate 50 and a plurality of semiconductor devices shown in FIG. 2. In FIG. 2, three semiconductor devices 53 are exemplified. The three semiconductor devices 53 have different heights from one another. The three semiconductor devices 53 are bonded to the substrate 50 through bonding portions 54.

The silver fine particles have a higher melting point than that of solder and a resin and have high heat resistance. As described above, the silver fine particles in a form of pellet having been baked in a nitrogen atmosphere at temperature of 100° C. for 1 hour have a volume resistivity of 15 μΩ·cm or lower and a volume contraction rate of 5% or more and, for example, 40% or less. In addition, the silver fine particles in a form of pellet having been baked in a nitrogen atmosphere at temperature of 150° C. for 1 hour have a volume resistivity of 10 μΩ·cm or lower and a volume contraction rate of 10% or more and, for example, 40% or less.

In addition, the silver fine particles in a form of pellet having been baked in the air at temperature of 150° C. for 1 hour have a volume resistivity of 10 μΩ·cm or lower and a volume contraction rate of 5% or more and, for example, 40% or less.

In view of the foregoing, even when the power semiconductor device 52 is operated and causes a temperature change, the bonding portion 54 would have a small volume change, thereby suppressing generation of cracks or the like. Owing to this constitution, the bonding is maintained, and high durability is achieved.

Furthermore, since the silver fine particles having been baked have a low volume resistivity, the heat conductivity is excellent, and the bonding portion 54 allows heat generated in the power semiconductor device 52 to be efficiently conducted to the substrate 50.

For bonding a plurality of semiconductor devices having different sizes as shown in FIG. 2, a semiconductor having a low height and a semiconductor having a high height have different distances to the substrate 50. Since the silver fine particles of the invention have a large volume contraction rate, even if pressure is applied to the substrate 50 to be bonded to a semiconductor device having a low height, a semiconductor device having a high height would not receive an excessive pressure.

For bonding the above-described three semiconductor devices 53 having different heights shown in FIG. 2 to the single substrate 50, by using the silver fine particles having a large volume contraction rate as a bonding material in a small gap between the semiconductor device 53 and the substrate 50 while using a bonding material having a small volume contraction rate in a large gap when the semiconductor devices are simultaneously pressurized to be bonded to the single substrate, the semiconductor devices 53 can be evenly pressurized, and sufficient bonding can be maintained.

The substrate 50 is, for example, a ceramic substrate of Si₃N₄ or the like on which copper wiring is provided. The power semiconductor device 52 is, for example, a semiconductor device using a semiconductor such as silicon carbide (SiC), gallium nitride (GaN), gallium oxide, or diamond.

The semiconductor device 53 is a semiconductor device using an ordinary silicon substrate. The semiconductor device 53 may be a power semiconductor device.

Use of the silver fine particles is not limited for bonding of the power semiconductor device 52 or the semiconductor device 53, and the silver fine particles can be also used for bonding of a high-frequency device, a light-emitting diode, a semiconductor laser, or the like. As described above, the silver fine particles have excellent heat conductivity and are suitable for bonding of a device that generates a large amount of heat and that is operated at high temperature.

In addition to bonding, the silver fine particles can be also used for various wiring including, for example, signal wiring and electric conduction wiring.

### [Production Method of Silver Fine Particles]

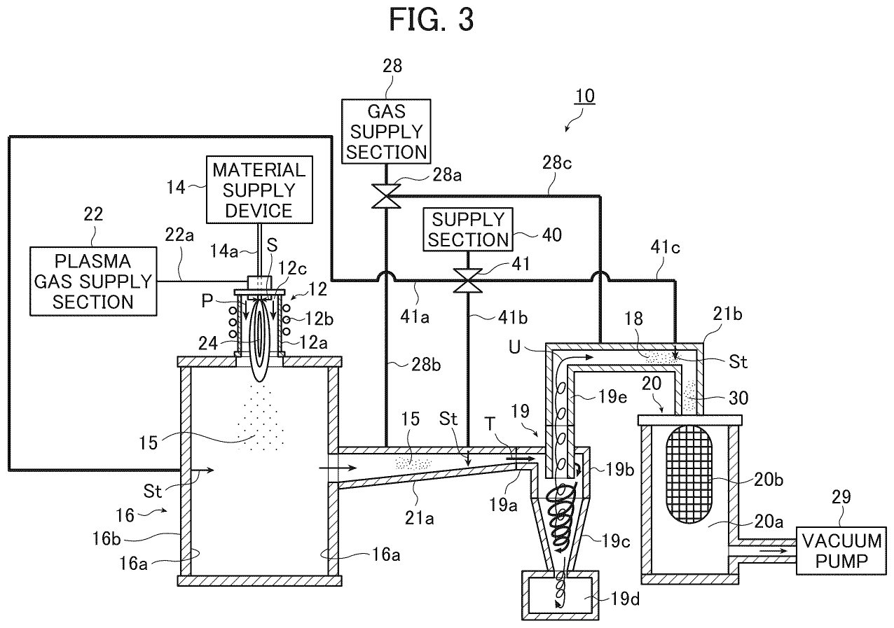

Next, an example of a production method of the silver fine particles is described with reference to FIG. 3, but the production method of the silver fine particles of the invention is not limited to a production method using a silver fine particle production apparatus 10 shown in FIG. 3.

FIG. 3 is a schematic view showing an example of a silver fine particle production apparatus of the invention. With the silver fine particle production apparatus 10 (hereinafter, simply referred to as “production apparatus 10”) shown in FIG. 3, the foregoing silver fine particles can be obtained.

The production apparatus 10 includes a plasma torch 12 generating a thermal plasma flame, a material supply device 14 supplying feedstock powder of silver fine particles into the plasma torch 12, a chamber 16 serving as a cooling tank for use in producing primary silver fine particles 15, a cyclone 19 removing, from the produced primary silver fine particles 15, coarse particles having a particle size equal to or larger than an arbitrarily specified particle size, and a collecting section 20 collecting secondary silver fine particles 18 having a desired particle size as obtained by classification by the cyclone 19. The chamber 16 is connected to the cyclone 19 through a connection tube 21a. The cyclone 19 is connected to the collecting section 20 through a connection tube 21b that is connected to an inner tube 19e.

The production apparatus 10 further includes a supply section 40 supplying a surface treating agent to the primary silver fine particles 15 or the secondary silver fine particles 18.

The primary silver fine particles 15 and the secondary silver fine particles 18 are both fine particle bodies produced in the middle of the production process of the fine particles of the invention. Those obtained by surface treating the primary silver fine particles 15 or the secondary silver fine particles 18, i.e., surface treated silver fine particles 30 are the fine particles of the invention. The silver fine particles 30 have a configuration where surfaces thereof are coated with an aliphatic amine.

For the material supply device 14, the chamber 16, the cyclone 19, and the collecting section 20, those devices described in, for example, JP 2007-138287 A may be used.

In the embodiment, for example, silver powder is used as the feedstock in the production of the fine particles. Silver powder is appropriately designed to have an average particle size which allows easy evaporation of the powder in a thermal plasma flame. The average particle size of silver powder is measured by a laser diffraction method and is, for example, not more than 100 μm, preferably not more than 50 μm, and more preferably not more than 15 μm.

The plasma torch 12 is constituted of a quartz tube 12a and a coil 12b for high frequency oscillation surrounding the outside of the quartz tube. A supply tube 14a to be described later which is for supplying feedstock powder of the fine particles into the plasma torch 12 is provided on the top of the plasma torch 12 at the central part thereof. A plasma gas supply port 12c is formed in the peripheral portion of the supply tube 14a (on the same circumference). The plasma gas supply port 12c is in a ring shape. To the coil 12b for high frequency oscillation, a power source (not shown) that generates a high frequency voltage is connected. When a high frequency voltage is applied to the coil 12b for high frequency oscillation, a thermal plasma flame 24 is generated. The feedstock (not shown) is evaporated by the thermal plasma flame 24 and transformed into a mixture in a gas phase state. The plasma torch 12 constitutes a treatment section transforming the feedstock into a mixture in a gas phase state by means of a gas-phase process.

A plasma gas supply section 22 is configured to supply plasma gas into the plasma torch 12. The plasma gas supply section 22 is connected to the plasma gas supply port 12c through a pipe 22a. Although not shown, the plasma gas supply section 22 is provided with a supply amount adjuster such as a valve for adjusting the supply amount. Plasma gas is supplied from the plasma gas supply section 22 into the plasma torch 12 through the plasma gas supply port 12c of ring shape in the direction indicated by arrow P and the direction indicated by arrow S.

For example, mixed gas of hydrogen gas and argon gas is used as plasma gas. In this case, hydrogen gas and argon gas are stored in the plasma gas supply section 22. Hydrogen gas and argon gas are supplied from the plasma gas supply section 22 into the plasma torch 12 in the direction indicated by arrow P and the direction indicated by arrow S after passing through the pipe 22a and then the plasma gas supply port 12c. Argon gas may be solely supplied in the direction indicated by arrow P.

As the plasma gas, a gas suitable for silver fine particles is selected and used; it is not essential to use mixed gas as described above, and one kind of gas may be used as the plasma gas.

When a high frequency voltage is applied to the coil 12b for high frequency oscillation, the thermal plasma flame 24 is generated in the plasma torch 12.

It is necessary for the thermal plasma flame 24 to have a higher temperature than the boiling point of the feedstock powder. A higher temperature of the thermal plasma flame 24 is more preferred because the feedstock powder is more easily transformed into a gas phase state; however, there is no particular limitation on the temperature. For instance, the thermal plasma flame 24 may have temperature of 6,000° C., and in theory, the temperature is deemed to reach around 10,000° C.

The ambient pressure inside the plasma torch 12 is preferably up to atmospheric pressure. For the atmosphere at a pressure up to atmospheric pressure, the pressure is not particularly limited and is, for example, in the range of 0.5 to 100 kPa.

The outside of the quartz tube 12a is surrounded by a concentrically formed tube (not shown), and cooling water is circulated between this tube and the quartz tube 12a to cool the quartz tube 12a with the water, thereby preventing the quartz tube 12a from having an excessively high temperature due to the thermal plasma flame 24 generated in the plasma torch 12.

The material supply device 14 is connected to the top of the plasma torch 12 through the supply tube 14a. The material supply device 14 is configured to supply the feedstock into the thermal plasma flame 24 in the plasma torch 12.

The material supply device 14 is not particularly limited as long as it can supply the feedstock into the thermal plasma flame 24, and, for example, the material supply device 14 supplies the feedstock into the thermal plasma flame 24 with the feedstock being dispersed in a particulate form.

When the feedstock is powder, for example, as described above, the device disclosed in JP 2007-138287 A may be used as the material supply device 14 that supplies silver powder in a powdery form. In this case, the material supply device 14 includes, for example, a storage tank (not shown) storing the feedstock, a screw feeder (not shown) transporting the feedstock in a fixed amount, a dispersion section (not shown) dispersing the feedstock transported by the screw feeder to transform it into the form of primary particles before the feedstock is finally sprayed, and a carrier gas supply source (not shown).

Together with carrier gas to which push-out pressure is applied from the carrier gas supply source, the feedstock is supplied into the thermal plasma flame 24 in the plasma torch 12 through the supply tube 14a.

The configuration of the material supply device 14 is not particularly limited as long as the device can prevent the feedstock from agglomerating, thus making it possible to spray the feedstock in the plasma torch 12 with the dispersed state maintained. Inert gas such as argon gas is used as the carrier gas, for example. The flow rate of the carrier gas can be controlled using, for example, a flowmeter such as a float type flowmeter. The flow rate value of the carrier gas is indicated by a reading on the flowmeter.

The chamber 16 is provided below and adjacent to the plasma torch 12, and in the chamber 16, the primary silver fine particles 15 being fine particle bodies are generated from the above-described mixture in a gas phase state with no use of a cooling gas. The chamber 16 serves as a cooling tank. A cooling gas is also called quenching gas, and for the cooling gas, argon gas is adopted for instance.

A gas supply section 28 is configured to, for example, supply a temperature adjusting gas including an inert gas into the connection tube 21a or the connection tube 21b. The gas supply section 28 supplies the temperature adjusting gas including an inert gas to the primary silver fine particles 15 or the secondary silver fine particles.

The gas supply section 28 includes a valve 28a, a first gas supply tube 28b, and a second gas supply tube 28c, the first and second gas supply tubes 28b, 28c being connected to the valve 28a. The first gas supply tube 28b is connected to the connection tube 21a, and the second gas supply tube 28c is connected to the connection tube 21b.

By switching the valve 28a, the temperature adjusting gas is supplied to either one of the first gas supply tube 28b and the second gas supply tube 28c, and the temperature adjusting gas is supplied into the connection tube 21a or the connection tube 21b.

The gas supply section 28 further includes a pressure application device (not shown) such as a compressor or a blower which applies push-out pressure to the temperature adjusting gas supplied into the first gas supply tube 28b or the second gas supply tube 28c.

Moreover, the gas supply section 28 includes a storage section (not shown) storing the temperature adjusting gas, and a pressure control valve controlling a gas supply amount. The temperature adjusting gas is argon gas for instance.

Owing to the temperature adjusting gas supplied from the gas supply section 28 to the connection tube 21a or the connection tube 21b, the gas temperature can be adjusted to a desired temperature.

As shown in FIG. 3, the cyclone 19 is provided to the chamber 16 to classify the primary silver fine particles 15 based on a desired particle size. The cyclone 19 includes an inlet tube 19a supplying the primary fine particles 15 from the chamber 16, a cylindrical outer tube 19b connected to the inlet tube 19a and positioned at an upper portion of the cyclone 19, a truncated conical part 19c continuing downward from the bottom of the outer tube 19b and having a gradually decreasing diameter, a coarse particle collecting chamber 19d connected to the bottom of the truncated conical part 19c and collecting coarse particles having a particle size equal to or larger than the above-mentioned desired particle size, and an inner tube 19e connected to the collecting section 20 to be detailed later and projecting from the outer tube 19b. The chamber 16 is connected to the inlet tube 19a via the connection tube 21a, and the primary fine particles 15 move to the cyclone 19 through the connection tube 21a. The connection tube 21a is the transport path of the primary fine particles 15.

A gas stream containing the primary fine particles 15 is blown from the inlet tube 19a of the cyclone 19 to flow along the inner peripheral wall of the outer tube 19b, and accordingly, this gas stream flows in the direction from the inner peripheral wall of the outer tube 19b toward the truncated conical part 19c as indicated by arrow T in FIG. 3, thus forming a downward swirling stream.

When the downward swirling stream is inverted to an upward stream, coarse particles cannot follow the upward stream due to the balance between the centrifugal force and drag, fall down along the lateral surface of the truncated conical part 19c and are collected in the coarse particle collecting chamber 19d. Fine particles having been affected by the drag more than the centrifugal force are discharged to the outside of the cyclone 19 through the inner tube 19e and the connection tube 21b with the upward stream on the inner wall of the truncated conical part 19c.

The apparatus is configured such that a negative pressure (suction force) is exerted from the collecting section 20 to be detailed later through the inner tube 19e and the connection tube 21b. Due to the negative pressure (suction force), the fine particles separated from the swirling gas stream are sucked as indicated by arrow U and sent to the collecting section 20 through the inner tube 19e and the connection tube 21b.

On the extension of the inner tube 19e which is an outlet for the gas stream in the cyclone 19, the collecting section 20 for collecting the silver fine particles 30 having a desired particle size on the order of nanometers is provided. The collecting section 20 includes a collecting chamber 20a, a filter 20b provided in the collecting chamber 20a, and a vacuum pump 29 connected through a tube provided at a lower portion of the collecting chamber 20a. The silver fine particles 30 delivered from the cyclone 19 are sucked by the vacuum pump 29 to be introduced into the collecting chamber 20a, and remain on the surface of the filter 20b and are then collected.

It should be noted that the number of cyclones used in the production apparatus 10 is not limited to one and may be two or more. Alternatively, no cyclone may be used.

The supply section 40 supplies a surface treating agent St to silver fine particles in the chamber 16, downstream of the first gas supply tube 28b in the connection tube 21a, or downstream of the second gas supply tube 28c in the connection tube 21b. Owing to the surface treating agent St, the silver fine particles whose surfaces are coated with an aliphatic amine are formed. Here, with reference to the connection tube 21a, the chamber 16 side is called “upstream side,” and the cyclone 19 side is called “downstream side.”

The supply section 40 includes, for example, a valve 41, a first supply tube 41a, a second supply tube 41b, and a third supply tube 41c, the first, second, and third supply tubes 41a, 41b, 41c being connected to the valve 41. The first supply tube 41a is connected to a lateral surface 16b of the chamber 16. The second supply tube 41b is connected to the connection tube 21a on the downstream side of the first gas supply tube 28b, and the third supply tube 41c is connected to the connection tube 21b on the downstream side of the second gas supply tube 28c. For instance, the first supply tube 41a is connected to the chamber 16 at a height similar to or lower than the position at which the connection tube 21a is connected to the chamber 16. The surface treating agent St is supplied into the chamber 16 through the first supply tube 41a from an inner wall 16a of the chamber 16.

The connection position of the second supply tube 41b to the connection tube 21a is defined as P₁, and the connection position of the third supply tube 41c to the connection tube 21b is defined as P₂. The connection position P₂ of the third supply tube 41c is situated on the downstream side from the connection position P₁ of the second supply tube 41b.

The supply section 40 supplies the surface treating agent St to the primary silver fine particles 15 in the chamber 16, the primary silver fine particles 15 passing through the connection tube 21a, or the secondary silver fine particles 18 passing through the connection tube 21b.

The supply section 40 supplies the surface treating agent St in a temperature region suitable for the surface treating agent St. The surface treating agent St is adhered to the primary silver fine particles 15 or the secondary silver fine particles 18, whereby the primary silver fine particles 15 or the secondary silver fine particles 18 are surface treated to form the silver fine particles whose surfaces are coated with an aliphatic amine. As a result, silver fine particles are prevented from fusing together, and the silver fine particles 30 are obtained.

The method for supplying the surface treating agent St with the supply section 40 is not particularly limited, and in an exemplary method, the surface treating agent St is transformed into droplets and sprayed to the secondary silver fine particles 18.

As described above, the surface treating agent St is supplied in a temperature region suitable therefor. A suitable temperature region means a temperature region in which the surface treating agent St can work to prevent silver fine particles from fusing together. Hence, as long as silver fine particles can be prevented from fusing together, the surface treating agent St may be introduced in a temperature region in which the surface treating agent St denatures or may be introduced in a temperature region in which the surface treating agent St does not denature.

The surface condition of the surface treated fine particles can be examined using, for instance, a Fourier transform infrared spectrometer (FT-IR).

The above-described temperature region in which the surface treating agent St can work to prevent silver fine particles from fusing together means a temperature region in which the primary fine particles 15 can be coated with an organic substance generated through denaturation of the surface treating agent St or with the surface treating agent St. The above-described temperature region in which the surface treating agent St does not denature means a temperature region determined from the temperature measurement by the thermogravimeter-differential thermal analysis (TG-DTA).

The temperature region in which the surface treating agent St does not denature is defined as a temperature region where the weight loss ratio is not more than 50 mass % in the thermogravimeter-differential thermal analysis of the surface treating agent St. The weight loss ratio is preferably not more than 30 mass %, and further preferably not more than 10 mass %.

In the thermogravimeter-differential thermal analysis, STA7200 (trade name) of Hitachi High-Technologies Corporation is used.

For the surface treating agent St, an aliphatic amine is adopted for instance. An aliphatic amine that is in the form of liquid when used is not necessarily required to be dissolved in a solvent, like an aqueous solution, and can be used alone.

An aliphatic amine has preferably 10 to 18 carbon atoms and more preferably 12 to 16 carbon atoms. Examples of the aliphatic amine include dodecylamine and hexadecyl amine. Dodecylamine and hexadecyl amine have a straight chain structure.

An example of usable dodecylamine is dodecylamine manufactured by FUJIFILM Wako Pure Chemical Corporation (product code 123-00246).

An example of usable hexadecyl amine is hexadecyl amine manufactured by FUJIFILM Wako Pure Chemical Corporation (product code 038-07162).

The surface treating agent St may contain an organic solvent.

### (Organic Solvent)

The organic solvent is not particularly limited and can be appropriately selected according to the intended purpose. Examples of the organic solvent include alcohols including methanol and ethanol, ketones including acetone, alkyl halides, amides including formamide, sulfoxides including dimethyl sulfoxide, a heterocyclic compound, hydrocarbons, esters including ethyl acetate, and the ethers. One kind thereof may be used alone, or two or more kinds thereof may be used in combination.

There may be provided a sensor (not shown) for measuring temperature of the transport path of the primary silver fine particles 15 or the secondary silver fine particles 18. The temperature measurement result of the sensor is utilized in determination of whether it falls in a temperature region suitable for the surface treating agent St. In this process, the temperature measurement result is output to the supply section 40, for example. The supply section 40 can determine whether it falls in a temperature region suitable for the surface treating agent St based on the temperature measurement result of the transport path of the primary silver fine particles 15 or the secondary silver fine particles 18 obtained by the sensor. When the temperature of the transport path of the primary silver fine particles 15 or the secondary silver fine particles 18 is in a temperature region unsuitable for the surface treating agent St, for example, the flow rate of the temperature adjusting gas supplied from the gas supply section 28 is changed.

Since the temperature measurement result obtained by the sensor is utilized in determination of whether it falls in a temperature region suitable for the surface treating agent St as described above, the sensor is preferably provided on the upstream side from the connection position P₁ of the second supply tube 41b to the connection tube 21a. Hence, the sensor is provided to the connection tube 21a for instance.

While the configuration of the sensor is not particularly limited as long as temperature can be measured, the measuring time is preferably short. Accordingly, for the sensor, use can make of, for example, resistance thermometer, radiation thermometer, infrared radiation thermometer, and thermistor.

Next, one example of the method of producing silver fine particles using the production apparatus 10 above is described below.

First, as the feedstock powder of the silver fine particles, for example, silver powder having an average particle size of not more than 15 μm is charged into the material supply device 14.

As the plasma gas, for example, argon gas and hydrogen gas are used, and a high frequency voltage is applied to the coil 12b for high frequency oscillation to generate the thermal plasma flame 24 in the plasma torch 12.

Next, the silver powder is transported with, for example, argon gas used as the carrier gas and supplied into the thermal plasma flame 24 in the plasma torch 12 through the supply tube 14a. The silver powder supplied is evaporated in the thermal plasma flame 24 to be transformed into a mixture in a gas phase state, from which the primary silver fine particles 15 are produced in the chamber 16 with no use of a cooling gas.

Then, the primary silver fine particles 15 thus obtained in the chamber 16 pass through the connection tube 21a and are blown in through the inlet tube 19a of the cyclone 19 together with a gas stream along the inner peripheral wall of the outer tube 19b, and accordingly, this gas stream flows along the inner peripheral wall of the outer tube 19b as indicated by arrow T in FIG. 3, thus forming a swirling stream which goes downward. When the downward swirling stream is inverted to an upward stream, coarse particles cannot follow the upward stream due to the balance between the centrifugal force and drag, fall down along the lateral surface of the truncated conical part 19c and are collected in the coarse particle collecting chamber 19d. Fine particles having been affected by the drag more than the centrifugal force are discharged along the inner wall of the truncated conical part 19c to the outside of the cyclone 19 together with the upward stream on the inner wall.

Due to the negative pressure (suction force) applied by the vacuum pump 29 through the collecting section 20, the discharged secondary silver fine particles 18 are sucked in the direction indicated by arrow U in FIG. 3 to pass through the inner tube 19e and the connection tube 21b.

When the primary silver fine particles 15 or the secondary silver fine particles 18 pass through the interior of the connection tube 21a or the connection tube 21b, the temperature adjusting gas is supplied from the gas supply section 28 into the connection tube 21a or the connection tube 21b through the first gas supply tube 28b or the second gas supply tube 28c to thereby cool the primary silver fine particles 15 or the secondary silver fine particles 18. Owing to the temperature adjusting gas, the temperature of the primary silver fine particles 15 or the secondary silver fine particles 18 is turned to fall in a temperature region suitable for the surface treating agent, and subsequently, the surface treating agent St in the form of, for example, spray is supplied from the supply section 40 to the primary silver fine particles 15 or the secondary silver fine particles 18 in the chamber 16, the connection tube 21a, or the connection tube 21b, to thereby surface treat the primary silver fine particles 15 or the secondary silver fine particles 18.

The primary silver fine particles 15 or secondary silver fine particles 18 thus surface treated, i.e., the silver fine particles 30 are transported to the collecting section 20 and collected by the filter 20b of the collecting section 20. The silver fine particles are obtained in this manner.

When the silver fine particles 30 are collected by the collecting section 20, the internal pressure of the cyclone 19 is preferably equal to or lower than the atmospheric pressure. For the particle size of the silver fine particles 30, an arbitrary particle size on the order of nanometers is specified according to the intended purpose.

While the primary silver fine particles are formed using a thermal plasma flame as a heat source in the invention, the primary silver fine particles may be formed by another gas-phase process. Thus, the method of forming the primary silver fine particles is not limited to the one using a thermal plasma flame as long as it is a gas-phase process, and may alternatively be one using a flame process, for example. Here, the method of forming the primary fine particles using a thermal plasma flame is called thermal plasma process.

The flame process herein is a method of synthesizing fine particles by using a flame as the heat source and putting a silver-containing feedstock through the flame. In the flame process, a silver-containing feedstock is supplied to a flame so that silver particles are generated in the flame, thus obtaining the primary silver fine particles 15. In addition, the surface treating agent St is supplied to the primary silver fine particles 15 or the secondary silver fine particles 18 to thereby produce the silver fine particles.

In the flame process, for the surface treating agent, the same agent as that mentioned for the thermal plasma process described above can also be used.

The present invention is basically configured as above. While the silver fine particles of the invention are described above in detail, the invention is by no means limited to the foregoing embodiment and it should be understood that various improvements and modifications are possible without departing from the scope and spirit of the invention.

### First Example

The silver fine particles of the invention are more specifically described below.

In First Example, silver fine particles of Examples 1 and 2 and silver fine particles of Comparative Example 1 were produced. To produce the silver fine particles of Examples 1 and 2 and the silver fine particles of Comparative Example 1, the production apparatus 10 shown in FIG. 3 was used. Shown below are the production conditions.

### Example 1

In Example 1, silver powder having an average particle size of 15 μm was used as the feedstock powder. The average particle size of the silver powder is a value measured with a particle size distribution meter. As the particle size distribution meter, MT3300 manufactured by MicrotracBEL Corp. was used.

As the production conditions of the silver fine particles, an input power to a plasma was set to be constant at 18 kW, and the pressure in the plasma torch was fixed at 60 kPa.

Argon gas was used as the carrier gas. The flow rate of argon gas was 5 L/minute (as being converted to standard conditions).

Argon gas and hydrogen gas were used as the plasma gas. The flow rate of argon gas was 200 L/minute (as being converted to standard conditions), and the flow rate of hydrogen gas was 5 L/minute (as being converted to standard conditions)).

Argon gas was used as the temperature adjusting gas. The flow rate of argon gas was 380 L/minute (as being converted to standard conditions).

As the surface treating agent, dodecylamine was used in Example 1. With ethanol being adopted as a solvent, a solution containing dodecylamine (dodecylamine concentration: 10.0 W/W %) was sprayed using a spray gas to the primary silver fine particles through the third supply tube 41c (see FIG. 3). Argon gas was used as the spray gas. Use was made of dodecylamine manufactured by FUJIFILM Wako Pure Chemical Corporation (product code 123-00246). Use was made of ethanol manufactured by JUNSEI CHEMICAL CO., LTD. (product code 17065-1283).

### Example 2

Example 2 is different from Example 1 in that hexadecyl amine was used as the surface treating agent. In Example 2, with ethanol being adopted as a solvent, a solution containing hexadecyl amine (hexadecyl amine concentration: 10.0 W/W %) was sprayed using a spray gas to the primary silver fine particles through the third supply tube 41c (see FIG. 3). Argon gas was used as the spray gas.

The flow rate of argon gas used as the temperature adjusting gas was 500 L/minute (as being converted to standard conditions) in Example 2.

Use was made of hexadecyl amine manufactured by FUJIFILM Wako Pure Chemical Corporation (product code 038-07162). Use was made of ethanol manufactured by JUNSEI CHEMICAL CO., LTD. (product code 17065-1283).

### Comparative Example 1

Comparative Example 1 was different from Example 1 in that a different surface treating agent was used, that the surface treating agent was supplied through the second supply tube 41b (see FIG. 3), and that the flow rate of the temperature adjusting gas was different, and Comparative Example 1 was otherwise the same as Example 1.

In Comparative Example 1, citric acid was used. With pure water being adopted as a solvent, an aqueous solution containing citric acid (citric acid concentration: 3.76 W/W %) was sprayed using a spray gas to the primary silver fine particles through the second supply tube 41b (see FIG. 3). Argon gas was used as the spray gas.

The flow rate of argon gas as the temperature adjusting gas was 500 L/minute (as being converted to standard conditions).

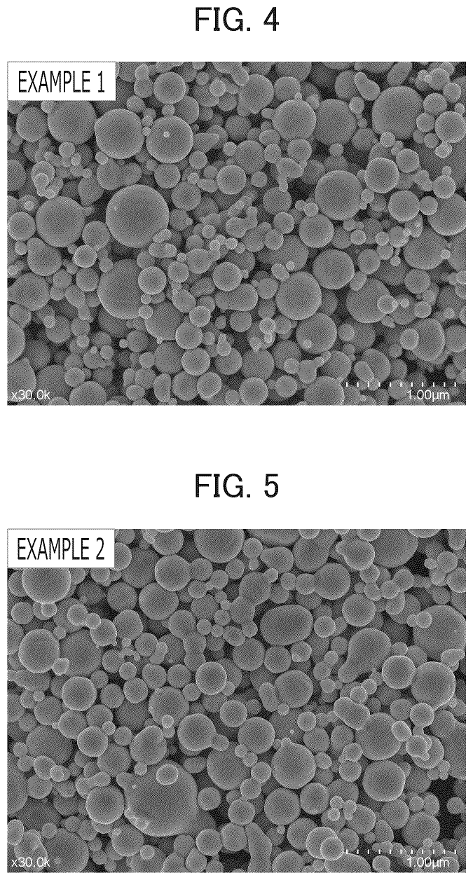

SEM images of the silver fine particles in Examples 1 and 2 were obtained. The SEM images were acquired using Regulus 8220 manufactured by Hitachi High-Technologies Corporation. FIG. 4 shows an SEM image of the silver fine particles in Example 1, and FIG. 5 shows an SEM image of the silver fine particles in Example 2.

To measure the particle sizes of the silver fine particles in Examples 1 and 2 and the silver fine particles in Comparative Example 1 by the BET method, Macsorb HM-1208 manufactured by Mountech Co., Ltd. was used.

The silver fine particles in Examples 1 and 2 and the silver fine particles in Comparative Example 1 were separately formed into pellets of cylindrical shape, and measured were the volume resistivity of each pellet before being baked, and the volume resistivity and the volume contraction rate of each pellet having been baked in a nitrogen atmosphere at temperature of 100° C. for 1 hour. The results are shown in Table 1 below.

A nitrogen atmosphere was an atmosphere where nitrogen gas of 99.99 purity (nitrogen: 99.99 vol %) was constantly circulated, and in the atmosphere, the oxygen concentration was 100 volume ppm or lower. The oxygen concentration was measured using a low concentration oxygen analyzer PS-820-L manufactured by Iijima Electronics Corporation.

For measuring the volume resistivity, the silver fine particles were pressed and retained at pressure of 127 MPa for 10 seconds with a pressing machine to thereby prepare a pellet of cylindrical shape. Loresta EP (MCP-T360) manufactured by Mitsubishi Chemical Corporation was used as a measurement device, and the volume resistivities of the pellet before and after the baking process were measured through the four-terminal method.

The pellet was placed in an electric furnace and baked in a nitrogen atmosphere at temperature of 100° C. for 1 hour.

For measuring the volume contraction rate, the silver fine particles were pressed and retained at pressure of 127 MPa for 10 seconds with a pressing machine to thereby prepare a pellet of cylindrical shape. The thickness and the diameter of the pellet of cylindrical shape were measured with a caliper, and the volume contraction rate was calculated based on the volumes of the pellet before and after the baking process. In the calculation of the volume contraction rate, the following formula was used. The pellet was placed in an electric furnace and baked in a nitrogen atmosphere at temperature of 100° C. for 1 hour.

Volume contraction rate (%)=100−((volume after baking/volume before baking)×100)

The density was measured as follows. The thickness and the diameter of the pellet of cylindrical shape before being baked were measured with a caliper, the mass of the pellet was measured with an electric balance, and based on the volume and the mass of the pellet of cylindrical shape, the density of the pellet of cylindrical shape before being baked was calculated. In addition, the thickness and the diameter of the pellet of cylindrical shape having been baked were measured with a caliper, the mass of the pellet was measured with an electric balance, and based on the volume and the mass of the baked pellet of cylindrical shape, the density of the pellet of cylindrical shape having been baked was calculated.

TABLE 1

| | | | Before baking process | | After baking process | | | |
|---|---|---|---|---|---|---|---|---|
| | | Particle | | Volume | | | Volume | Volume |
| | Surface treating | size | Density | resistivity | Baking | Density | resistivity | contraction |
| | agent | (nm) | (g/cm³) | (μΩ · cm) | conditions | (g/cm³) | (μΩ · cm) | rate (%) |
| CE 1 | Citric acid | 255 | 6.87 | 47.9 | Nitrogen | 6.99 | 35.0 | 2.0 |
| EX 1 | Dodecylamine | 344 | 7.23 | 31.5 | atmosphere | 7.73 | 7.1 | 6.5 |
| EX 2 | Hexadecyl amine | 374 | 6.59 | 43.3 | 100° C., | 6.94 | 14.3 | 5.4 |
| | | | | | 1 hour | | | |

CE: Comparative Example
EX: Example

As shown in Table 1, the silver fine particles of Examples 1 and 2 had larger particle sizes than that of the silver fine particles of Comparative Example 1. The silver fine particles of Examples 1 and 2 formed into pellets of cylindrical shape and baked in a nitrogen atmosphere at temperature of 100° C. for 1 hour had smaller volume resistivities and larger volume contraction rates than those of the silver fine particles of Comparative Example 1.

### Second Example

In Second Example, silver fine particles of Examples 10 to 13 and silver fine particles of Comparative Example 10 were produced. To produce the silver fine particles of Examples 10 to 13 and the silver fine particles of Comparative Example 10, the production apparatus 10 shown in FIG. 3 was used. Shown below are the production conditions.

### Example 10

Example 10 was the same as Example 1 of First Example.

### Example 11

Example 11 was different from Example 1 of First Example in that the pressure in the plasma torch was 85 kPa, that the dodecylamine concentration was 1.5 W/W %, and that the flow rate of argon gas as the temperature adjusting gas was 150 L/minute (as being converted to standard conditions), and was otherwise the same as Example 1.

### Example 12

Example 12 was the same as Example 2 of First Example.

### Example 13

Example 13 was different from Example 2 of First Example in that the pressure in the plasma torch was 85 kPa, and that the hexadecylamine concentration was 1.5 W/W %, and was otherwise the same as Example 2.

### Comparative Example 10

Comparative Example 10 was the same as Comparative Example 1 of First Example.

In Second Example, SEM images (not shown) of the silver fine particles of Examples 10 to 13 were obtained. The SEM images were acquired using Regulus 8220 manufactured by Hitachi High-Technologies Corporation. It was confirmed that the silver fine particles of Examples 10 to 13 were similar to the silver fine particles of Example 1 shown in FIG. 4 and the silver fine particles of Example 2 shown in FIG. 5 described above.

To measure the particle sizes of the silver fine particles of Examples 10 to 13 and the silver fine particles of Comparative Example 10 by the BET method, Macsorb HM-1208 manufactured by Mountech Co., Ltd. was used.

As with First Example described above, in Second Example, the silver fine particles of Examples 10 to 13 and the silver fine particles of Comparative Example 10 were separately formed into pellets of cylindrical shape, and measured were the volume resistivity of each pellet before being baked, and the volume resistivity and the volume contraction rate of each pellet having been baked in a nitrogen atmosphere at temperature of 150° C. for 1 hour. The results are shown in Table 2 below. The nitrogen atmosphere was the same as that of First Example described above. The volume resistivity was measured in the same manner as that of First Example described above. The density was measured also in the same manner as that of First Example described above.

The pellet was placed in an electric furnace and baked in a nitrogen atmosphere at temperature of 150° C. for 1 hour.

The volume contraction rate was measured in the same manner as that of First Example described above. The pellet was placed in an electric furnace and baked in a nitrogen atmosphere at temperature of 150° C. for 1 hour.

TABLE 2

| | | | Before baking process | | After baking process | | | |
|---|---|---|---|---|---|---|---|---|
| | | Particle | | Volume | | | Volume | Volume |
| | Surface treating | size | Density | resistivity | Baking | Density | resistivity | contraction |
| | agent | (nm) | (g/cm³) | (μΩ · cm) | conditions | (g/cm³) | (μΩ · cm) | rate (%) |
| CE 10 | Citric acid | 255 | 6.87 | 47.9 | Nitrogen | 7.70 | 5.6 | 8.1 |
| EX 10 | Dodecylamine | 344 | 7.23 | 31.5 | atmosphere | 8.42 | 3.1 | 13.3 |
| EX 11 | Dodecylamine | 484 | 7.55 | 16.2 | 150° C., | 8.45 | 9.1 | 10.8 |
| EX 12 | Hexadecyl amine | 374 | 6.59 | 43.3 | 1 hour | 7.76 | 5.7 | 15.2 |
| EX 13 | Hexadecyl amine | 583 | 7.59 | 36.5 | | 8.43 | 6.2 | 10.1 |

CE: Comparative Example
EX: Example

As shown in Table 2, the particle sizes of the silver fine particles of Examples 10 to 13 were larger than that of the silver fine particles of Comparative Example 10. The silver fine particles of Examples 10 to 13 formed into pellets of cylindrical shape and baked in a nitrogen atmosphere at temperature of 150° C. for 1 hour were able to attain both a small volume resistivity and a large volume contraction rate, compared to the silver fine particles of Comparative Example 10.

### Third Example

In Third Example, silver fine particles of Examples 20 to 25 and silver fine particles of Comparative Examples 20 to 22 were produced. To produce the silver fine particles of Examples 20 to 25 and the silver fine particles of Comparative Examples 20 to 22, the production apparatus 10 shown in FIG. 3 was used. Shown below are the production conditions.

### Example 20

Example 20 was the same as Example 1 of First Example.

### Example 21

Example 21 was different from Example 1 of First Example in that the pressure in the plasma torch was 85 kPa, that the dodecylamine concentration was 0.5 W/W %, and that the flow rate of argon gas as the temperature adjusting gas was 150 L/minute (as being converted to standard conditions), and was otherwise the same as Example 1.

### Example 22

Example 22 was the same as Example 11 of Second Example.

### Example 23

Example 23 was the same as Example 2 of First Example.

### Example 24

Example 24 was different from Example 2 of First Example in that the pressure in the plasma torch was 85 kPa, that the hexadecylamine concentration was 0.5 W/W %, and that the flow rate of argon gas as the temperature adjusting gas was 150 L/minute (as being converted to standard conditions), and was otherwise the same as Example 2.

### Example 25

Example 25 was the same as Example 13 of Second Example.

### Comparative Example 20

Comparative Example 20 was different from Example 1 of First Example in that a cooling gas was used, that a different surface treating agent was used, that the surface treating agent was supplied from the first supply tube 41a (see FIG. 3), and that the temperature adjusting gas was not used, and was otherwise the same as Example 1. Argon gas and methane gas were used as the cooling gas. The flow rate of argon gas was 800 L/minute (as being converted to standard conditions), and the flow rate of methane gas was 1 L/minute (as being converted to standard conditions)).

In Comparative Example 20, citric acid was used as an organic acid. Pure water was used as a solvent, and an aqueous solution containing citric acid (citric acid concentration: 18.8 W/W %) was sprayed from the first supply tube 41a (see FIG. 3) to the primary silver fine particles with use of a spray gas. Argon gas was used as the spray gas.

### Comparative Example 21

Comparative Example 21 was different from Comparative Example 20 in that the cooling gas was not used, that the citric acid concentration was 3.76 W/W %, that the surface treating agent was supplied from the second supply tube 41b (see FIG. 3), and that the temperature adjusting gas was used, and was otherwise the same as Comparative Example 20.

The flow rate of argon gas as the temperature adjusting gas was 240 L/minute (as being converted to standard conditions).

### Comparative Example 22

Comparative Example 22 was different from Comparative Example 21 in that the pressure in the plasma torch was 85 kPa, and that the flow rate of the temperature adjusting gas was different, and was otherwise the same as Comparative Example 21.

The flow rate of argon gas as the temperature adjusting gas was 15 L/minute (as being converted to standard conditions).

In Third Example, SEM images (not shown) of the silver fine particles of Examples 20 to 25 were obtained. The SEM images were acquired using Regulus 8220 manufactured by Hitachi High-Technologies Corporation. It was confirmed that the silver fine particles of Examples 20 to 25 were similar to the silver fine particles of Example 1 shown in FIG. 4 and the silver fine particles of Example 2 shown in FIG. 5 described above.

To measure the particle sizes of the silver fine particles of Examples 20 to 25 and the silver fine particles of Comparative Examples 20 to 22 by the BET method, Macsorb HM-1208 manufactured by Mountech Co., Ltd. was used.

As with First Example described above, in Third Example, the silver fine particles of Examples 20 to 25 and the silver fine particles of Comparative Examples 20 to 22 were separately formed into pellets of cylindrical shape, and measured were the volume resistivity of each pellet before being baked, and the volume resistivity and the volume contraction rate of each pellet having been baked in the air at temperature of 150° C. for 1 hour. The results are shown in Table 3 below. The air had the composition as described above.

The volume resistivity was measured in the same manner as that of First Example described above. The density was measured also in the same manner as that of First Example described above.

The pellet was placed in an electric furnace and baked in the air at temperature of 150° C. for 1 hour.

The volume contraction rate was measured in the same manner as that of First Example described above. The pellet was placed in an electric furnace and baked in the atmosphere at temperature of 150° C. for 1 hour.

TABLE 3

| | | | Before baking process | | After baking process | | | |
|---|---|---|---|---|---|---|---|---|
| | | Particle | | Volume | | | Volume | Volume |
| | Surface treating | size | Density | resistivity | Baking | Density | resistivity | contraction |
| | agent | (nm) | (g/cm³) | (μΩ · cm) | conditions | (g/cm³) | (μΩ · cm) | rate (%) |
| CE 20 | Citric acid | 115 | 6.74 | 36.0 | Air | 6.99 | 7.0 | 4.3 |
| CE 21 | Citric acid | 192 | 7.19 | 68.1 | 150° C., | 7.38 | 8.3 | 2.9 |
| CE 22 | Citric acid | 356 | 7.23 | 31.0 | 1 hour | 7.21 | 6.8 | 0 |
| EX 20 | Dodecylamine | 344 | 7.23 | 31.5 | | 7.90 | 7.1 | 7.8 |
| EX 21 | Dodecylamine | 477 | 7.37 | 13.5 | | 7.79 | 5.7 | 5.5 |
| EX 22 | Dodecylamine | 484 | 7.55 | 16.2 | | 6.21 | 5.5 | 6.2 |
| EX 23 | Hexadecyl amine | 374 | 6.59 | 43.3 | | 7.21 | 4.9 | 6.3 |
| EX 24 | Hexadecyl amine | 524 | 7.39 | 10.8 | | 7.80 | 6.6 | 5.2 |
| EX 25 | Hexadecyl amine | 583 | 7.59 | 36.5 | | 8.33 | 6.1 | 7.0 |

CE: Comparative Example
EX: Example

As shown in Table 3, the particle sizes of the silver fine particles of Examples 20 to 25 were larger than those of the silver fine particles of Comparative Examples 20 to 22. The silver fine particles of Examples 20 to 25 formed into pellets of cylindrical shape and baked in the air atmosphere at temperature of 150° C. for 1 hour were able to attain both a small volume resistivity and a large volume contraction rate, compared to the silver fine particles of Comparative Examples 20 to 22.

### REFERENCE SIGNS LIST

10 silver fine particle production apparatus (production apparatus)
12 plasma torch
12a quartz tube
12b coil for high frequency oscillation
12c plasma gas supply port
14 material supply device
14a supply tube
15 primary fine particle
16 chamber
16a inner wall
16b lateral surface
18 secondary fine particle
19 cyclone
19a inlet tube
19b outer tube
19c truncated conical part
19d coarse particle collecting chamber
19e inner tube
20 collecting section
20a collecting chamber
20b filter
21a, 21b connection tube
22 plasma gas supply section
22a pipe
24 thermal plasma flame
28 gas supply section
28a valve
28b first gas supply tube
28c second gas supply tube
29 vacuum pump
30 silver fine particle
40 supply section
41 valve
41a first supply tube
41b second supply tube
41c third supply tube
50 substrate
52 power semiconductor device
53 semiconductor device
54 bonding portion
St surface treating agent

1. Silver fine particles, wherein a particles size measured by BET method is 0.1 μm or more and 1 μm or less, and
the silver fine particles in a form of pellet having been baked in a nitrogen atmosphere at temperature of 100° C. for 1 hour has a volume resistivity of 15 μΩ·cm or lower and a volume contraction rate of 5% or more.

2. Silver fine particles, wherein a particles size measured by BET method is 0.1 μm or more and 1 μm or less, and
the silver fine particles in a form of pellet having been baked in a nitrogen atmosphere at temperature of 150° C. for 1 hour has a volume resistivity of 10 μΩ·cm or lower and a volume contraction rate of 10% or more.

3. Silver fine particles, wherein a particles size measured by BET method is 0.1 μm or more and 1 μm or less, and
the silver fine particles in a form of pellet having been baked in air at temperature of 150° C. for 1 hour has a volume resistivity of 10 μΩ·cm or lower and a volume contraction rate of 5% or more.

4. The silver fine particles according to claim 1, wherein surfaces of the silver fine particles are covered by an aliphatic amine.

5. The silver fine particles according to claim 4, wherein the aliphatic amine has 10 to 18 carbon atoms.

6. The silver fine particles according to claim 2, wherein surfaces of the silver fine particles are covered by an aliphatic amine.

7. The silver fine particles according to claim 6, wherein the aliphatic amine has 10 to 18 carbon atoms.

8. The silver fine particles according to claim 3, wherein surfaces of the silver fine particles are covered by an aliphatic amine.

9. The silver fine particles according to claim 8, wherein the aliphatic amine has 10 to 18 carbon atoms.
